(19) United States
(12) Patent Application Publication
(10) Pub. No.: US 2024/0232783 A1
(43) Pub. Date: Jul. 11, 2024

(54) METHOD AND SYSTEM FOR PROVIDING DOMAIN-SPECIFIC PROCESS FRAMEWORK

(71) Applicant: KOREA ELECTRONICS TECHNOLOGY INSTITUTE, Seongnam-si (KR)

(72) Inventors: Hwa Seon SHIN, Yongin-si (KR); Hye In LEE, Anyang-si (KR); Jae Ho SHIN, Hanam-si (KR); Sung Hwan CHUN, Seoul (KR); Sung Hun PARK, Seoul (KR)

(73) Assignee: KOREA ELECTRONICS TECHNOLOGY INSTITUTE, Seongnam-si (KR)

(21) Appl. No.: 18/572,514

(22) PCT Filed: Dec. 14, 2022
(86) PCT No.: PCT/KR2022/020292

§ 371 Date: Dec. 20, 2023

(30) Foreign Application Priority Data
Dec. 16, 2021 (KR) 10-2021-0180722

(51) Int. Cl. G06Q 10/067; G06F 8/35

(52) U.S. Cl. CPC G06Q 10/067; G06F 8/35

(57) ABSTRACT

A method and a system for providing a domain-based process framework are provided. The method for providing a domain-specific process framework, according to one embodiment of the present invention, comprises steps in which: a process framework provision system generates a process model on the basis of a pre-stored meta-model (primitive) and a relationship model (relation); and the process framework provision system distributes the generated process model. Therefore, a process framework capable of reflecting domain knowledge is introduced so that different business processes between companies can be normalized by domain.

### TECHNICAL FIELD

The disclosure relates to a business process management method and system, and more particularly, to a method and a system for providing a domain-based process framework.

### BACKGROUND ART

Since related-art business processes are dealt with in all areas without distinguishing between business areas, it may be difficult or complicated to constitute process models.

In addition, business processes used in companies are constituted according to their respective schemes, and also, there is no accurate analysis thereof. To this end, complicated processes may be closely intertwined and exceptional circumstances may also be inevitable when processes are performed.

Log data generated through business processes may not be easy to analyze due to disorganized processes.

### DISCLOSURE

### Technical Problem

The disclosure has been developed in order to address the above-discussed deficiencies of the prior art, and an object of the disclosure is to provide a method and a system for providing a process framework, which can normalize different business processes between companies by domain through domain-specific modeling.

### Technical Solution

According to an embodiment of the disclosure to achieve the above-described object, a domain-specific process framework providing method may include: a step of generating, by a process framework providing system, a process model based on a metamodel (Primitive) and a relation model (Relation) which are pre-stored; and a step of distributing, by the process framework providing system, the generated process model.

The process framework providing system may include: a framework driving engine (runtime engine) configured to support the generated process model to be driven in a real business environment; and a work model driving code generation module (code generator) configured to transform the process model into a code that is executable in the framework driving engine.

In addition, the step of generating the process model may include: a step of generating the process model based on domain knowledge which is provided from a specific company which intends to drive a process model; and a step of transforming the generated process model into a code that is executable in the framework driving engine.

The metamodel may be created in a process modeling language of any one of a domain-specific language (DSL), a business process model and notation (BPMN), and a UML activity diagram.

The process framework providing system may further include a process development environment providing module configured to provide an edit environment for generating the process model.

The process development environment providing module may provide at least one edit environment among a first edit environment in which a metamodel (Primitive) is edited based on a process modeling language (Process DSL), a second edit environment in which a relation model (Relation) indicating a connection state between respective metamodels (Primitive) is edited, and a third edit environment in which a form to receive an input from a user is edited.

The process framework providing system may further include: a metamodel repository configured to store a metamodel; and a relation model repository configured to store a relation model.

In addition, according to an embodiment of the disclosure, the domain-specific process framework providing method of claim may further include a step of validating, by the process framework providing system, a process of the generated process model before the generated process model is distributed.

In addition, the process framework providing system may further include a business process visualization engine configured to visualize the generated process model. In this case, the business process visualization engine may visualize components constituting the process model with a line, a graph, or a 3D shape.

According to another embodiment of the disclosure, a domain-specific process framework providing system may include: a storage unit configured to store a metamodel (Primitive) and a relation model (Relation); and a processor configured to generate a process model based on the metamodel (Primitive) and the relation model (Relation) which are stored, and to distribute the generated process model.

According to still another embodiment of the disclosure, a domain-specific process framework providing method may include: a step of generating, by a process framework providing system, a process model based on a metamodel (Primitive) and a relation model (Relation) which are pre-stored; and a step of transforming, by the process framework providing system, the generated process model into a code that is executable in a framework driving engine which supports a generated process model to be driven in a real business environment.

According to yet another embodiment of the disclosure, a domain-specific process framework providing system may include: a work model generation module configured to generate a process model based on a metamodel (Primitive) and a relation model (Relation) which are pre-stored; and a work model driving code generation module configured to transform the generated process model into a code that is executable in a framework driving engine which supports a generated process model to be driven in a real business environment.

### Advantageous Effects

According to embodiments of the disclosure as described above, a process framework capable of reflecting domain knowledge may be introduced, so that different business processes between companies can be normalized by domain.

### DESCRIPTION OF DRAWINGS

FIG. 1 is a view provided to explain a process analysis method and a metamodel framework-based analysis method;

FIG. 2 is a view provided to explain a metamodel framework-based process normalization process;

FIG. 3 is a view provided to explain a domain-specific process framework providing system according to an embodiment of the disclosure;

FIG. 4 is a view provided to explain a processor in detail according to an embodiment of the disclosure;

FIG. 5 is a view provided to explain a business process automation engine according to an embodiment of the disclosure;

FIG. 6 is a view illustrating a development environment in which a process model is generated (defined) according to an embodiment of the disclosure;

FIG. 7 is a view provided to explain a storage unit in detail according to an embodiment of the disclosure;

FIG. 8 is a view provided to explain a process framework domain knowledge reflection process according to an embodiment of the disclosure;

FIG. 9 is a view provided to explain a process framework distribution process according to an embodiment of the disclosure;

FIGS. 10 and 11 are views provided to explain a structure of a process framework according to an embodiment of the disclosure;

FIG. 12 is a view provided to explain a detailed structure of a domain-specific process framework providing system according to an embodiment of the disclosure; and

FIG. 13 is a view provided to explain a domain-specific process framework providing method according to an embodiment of the disclosure.

### BEST MODE

Hereinafter, the disclosure will be described in more detail with reference to the drawings.

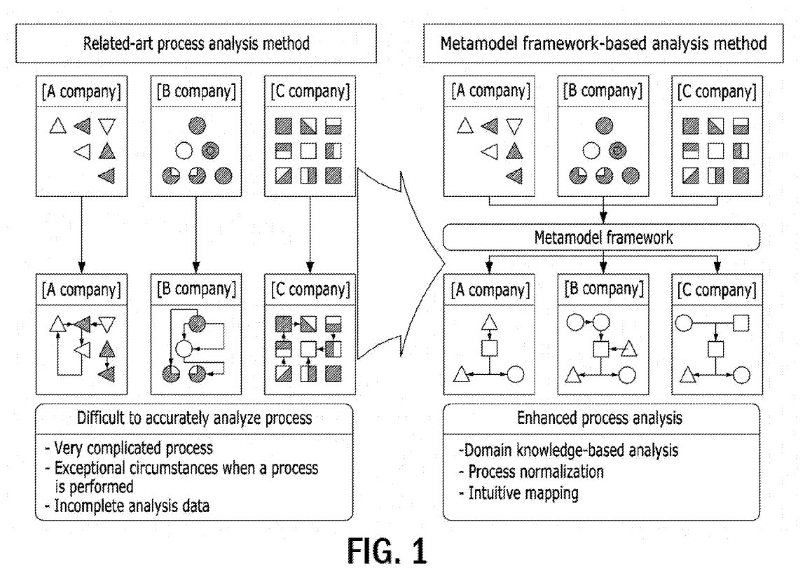

FIG. 1 is a view provided to explain a process analysis method and a metamodel framework-based analysis method.

A domain-specific process framework providing system according to an embodiment is to solve a business process normalization problem through domain-specific modeling.

As shown in FIG. 1, process analysis methods are constituted by companies according to their respective schemes, and thus it is not easy to accurately analyze business processes.

On the other hand, a domain-specific modeling (DSM) technique is a modeling technique that generates a model optimized to a domain based on domain information, and a business process for each company may be intuitively constituted (mapped) through a metamodel framework based on DSM.

Accordingly, a domain-specific process framework providing system according to an embodiment introduces a process framework capable of reflecting domain knowledge, and normalizes different processes between companies by domain. Through this, a process model which is specialized for a specific business area may be defined and driven through a domain-specific process framework technique.

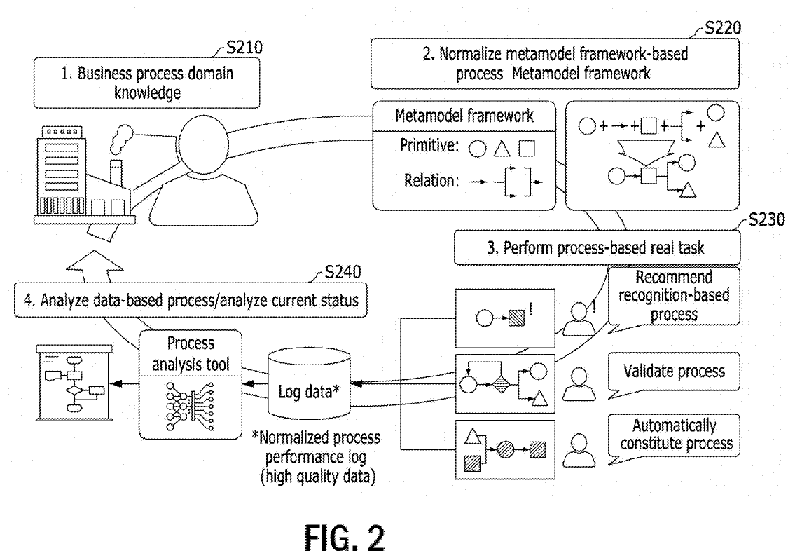

FIG. 2 is a view provided to explain a metamodel framework-based process normalization process.

Referring to FIG. 2, a process of normalizing a process based on a metamodel framework may include collecting domain knowledge with a domain specialist of a business process and accumulating the domain knowledge (S210), and generate a process model which is specialized for a corresponding domain, based on the accumulated domain knowledge (S220).

In this case, the process model may be generated by using a metamodel (primitive) and a relation model (Relation) which are provided by a metamodel framework.

When a real task is performed, the generated process models may be applied to validate a process based on a validation model built therein or provide a service for automatically constituting a process (S230).

In addition, log data which is stored while a real task is being performed may be used for automatically analyzing through a process analysis tool (an external module) (S240).

In this case, since log data is a result from a normalized process, the log data may enhance performance of analysis performed by the process analysis tool and hence may increase availability regarding a result of analysis.

In addition, a process function/performance enhancement procedure may be performed by comparing based on a log-based process analysis result and a currently normalized process and discussing with a domain specialist.

A domain-specific process framework providing system which provides such a process framework may periodically enhance a process through the above-described normalizing process, and may enhance work efficiency through this procedure.

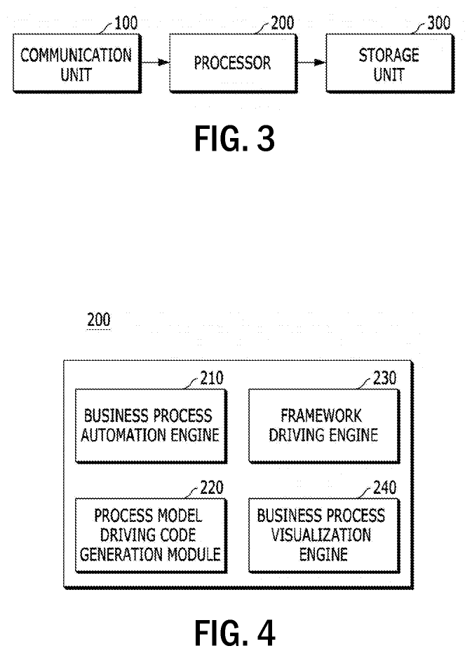

FIG. 3 is a view provided to explain a domain-specific process framework providing system according to an embodiment of the disclosure.

The domain-specific process framework providing system (hereinafter, referred to as a “process framework providing system”) according to an embodiment may include a communication unit 100, a processor 200, and a storage unit 300 to normalize different business processes between companies by domain through domain-specific modeling.

The communication unit 100 may include a communication module which is connected with an external server such as a company server and a terminal wiredly or wirelessly to exchange data.

Specifically, the communication unit 100 may be connected with an external server and a terminal to collect domain knowledge or to distribute a process model generated through the processor 200.

The processor 200 may generate a process model based on a metamodel (Primitive) and a relation model (Relation) which are stored in the storage unit 300, and may transform the generated process model into a code that is executable in a framework driving engine 230, which supports a process model to be driven in a real business environment, and may distribute the code to a company server and a terminal which need the code.

The storage unit 300 may store a program and data necessary for operating the processor 200.

For example, the storage unit 300 may store a metamodel (Primitive) and a relation model (Relation) that a metamodel framework will provide.

In addition, the storage unit 300 may store a validation model that validates a process of a generated process model.

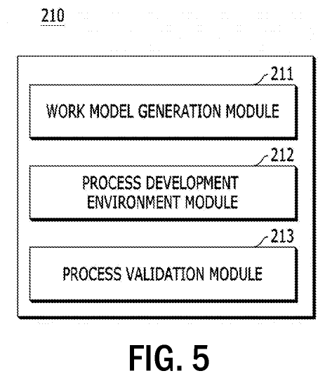

FIG. 4 is a view provided to explain the processor 200 in detail according to an embodiment of the disclosure.

Referring to FIG. 4, the processor 200 according to an embodiment may include a business process automation engine 210, a process model driving code generation module 220, a framework driving engine 230, and a business process visualization engine 240 to generate a process model based on a metamodel (Primitive) and a relation model (Relation) which are stored in the storage unit 300, to transform the generated process model into a code that is executable in the framework driving engine 230 which supports a process model to be driven in a real business environment, and to distribute the code to a company server and a terminal which need the code.

The business process automation engine 210 may generate a process model based on domain knowledge which is provided from a specific company which intends to drive a process model.

The process model driving code generation module 220 may transform a process model into a code that is executable in the framework driving engine 230.

The framework driving engine 230 may support a generated process model to be driven in a real business environment.

The business process visualization engine 240 may visualize a generated process model.

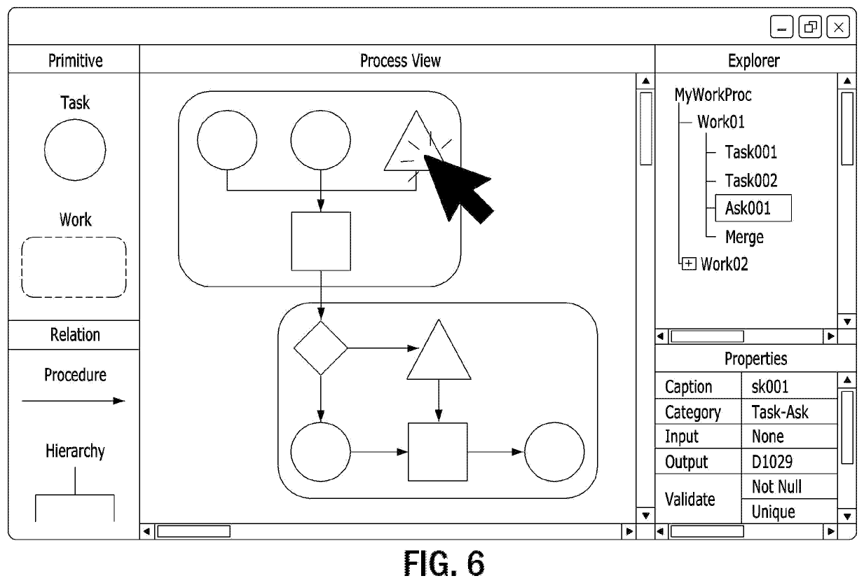

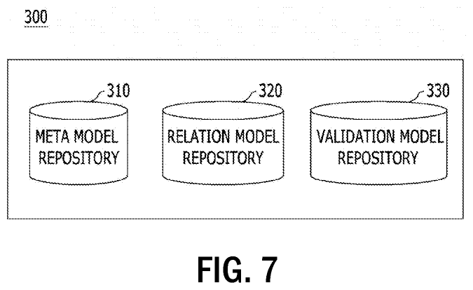

FIG. 5 is a view provided to explain the business process automation engine 210 in detail according to an embodiment of the disclosure, and FIG. 6 is a view illustrating a development environment in which a process model is generated (defined) according to an embodiment of the disclosure.

Referring to FIG. 5, the business process automation engine 210 according to an embodiment may include a work model generation module 211, a process development environment providing module 212, and a process validation module 213.

The work model generation module 211 may generate a process model based on information which is inputted through a process development environment (user interface (UI)) provided through the process development environment providing module 212.

As shown in FIG. 6, the process development environment providing module 212 may provide a process development environment to receive information necessary for generated a process model.

For example, the process development environment providing module 212 may provide at least one edit environment among a first edit environment in which a metamodel (Primitive) is edited based on a process modeling language (Process DSL), a second edit environment in which a relation model (Relation) indicating a connection state between metamodels (Primitive) is edited, and a third edit environment in which a form to receive an input from a user is edited.

A user may generate a process model which is based on a metamodel (Primitive) and a relation model (Relation) through the process development environment provided through the process development environment providing module 212.

Specifically, the process development environment provided through the process development environment providing module 212 may express the metamodel (Primitive) and the relation model (Relation) with graphical components, so that a process model is constituted by dragging components through an input device such as a mouse and setting a relation between components.

In this case, a hierarchy between components, that is, an include relationship, may be designated, and an attribute of each component may be set through an individual attribute window.

All components (a metamodel, a sequential relation model, a hierarchical relation model, an attribute of each component) used herein are matters that are set in the business process automation engine 210, and may be designed to be specialized for a domain describing a business process, may go through a validation process, and then, may be distributed.

The process validation module 213 may validate a process of a generated process model by using a validation model stored in the storage unit 300.

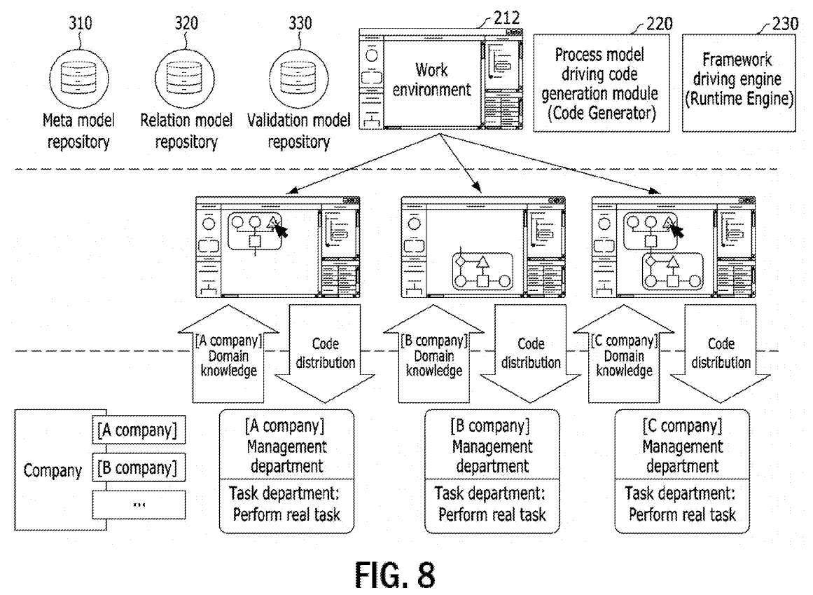

FIG. 7 is a view provided to explain the storage unit 300 in detail according to an embodiment of the disclosure.

Referring to FIG. 7, the storage unit 300 may include a metamodel repository 310, a relation model repository 320, and a validation model repository 330.

The metamodel repository 310 and the relation model repository 320 may store a metamodel (Primitive) and a relation model (Relation) which are provided by a metamodel framework, respectively.

For example, the metamodel repository 310 may store a task metamodel corresponding to a metamodel of a basic task unit, a work metamodel including one or more tasks, and a trigger metamodel which is used for setting an operational condition of the task metamodel or work metamodel, and the relation model repository 320 may store a sequential relation model, a hierarchical relation model, and a reference relation model.

The validation model repository 330 may store a validation model for validating a process of a generated process model.

For example, the validation model repository 330 may include a connection validation model to validate a connection between metamodels, a procedure validation model to validate a procedure between metamodels, and a meaning validation model to validate an individual attribute of a metamodel.

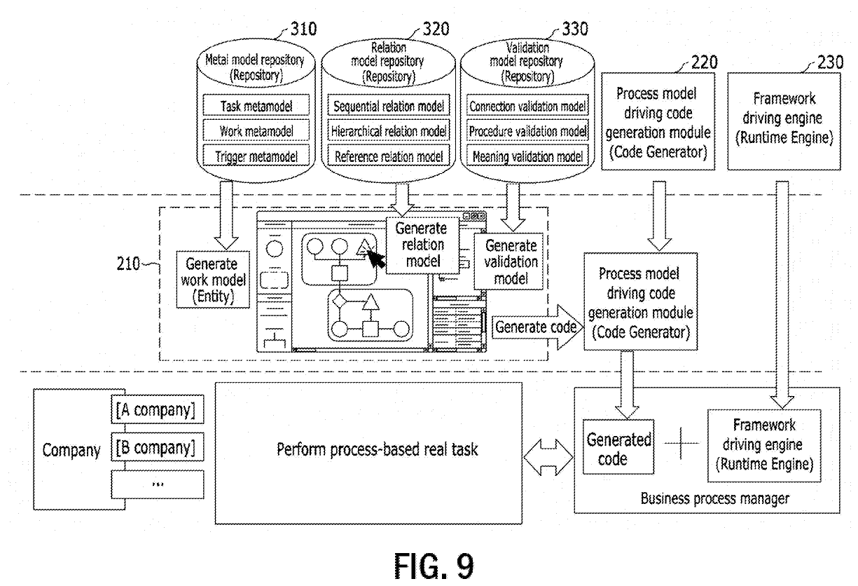

FIG. 8 is a view provided to explain a process framework domain knowledge reflection process according to an embodiment of the disclosure.

In order to collect and accumulate domain acknowledge from users of companies (domain specialists), the process framework providing system may provide a work environment (UI) application for generating a process model, and a metamodel, a relation model, and a validation model which are accessible in a work environment.

In addition, the process framework providing system may also provide the framework driving engine 230 which supports a process model (or a work model) to be driven in a real business environment, and the process model driving code generation module 220 which transforms a process model into a code that is executable in an engine.

The process framework providing system may generate process models which are appropriate for respective companies, based on domain knowledge and requests received from users of companies, and may transform the generated process model into a code that is executable in the framework driving engine 230 and may provide the code to users of the companies.

Through this, companies A, B, C of FIG. 8 use their respective unique process models, and also, use a consistent process model in each domain.

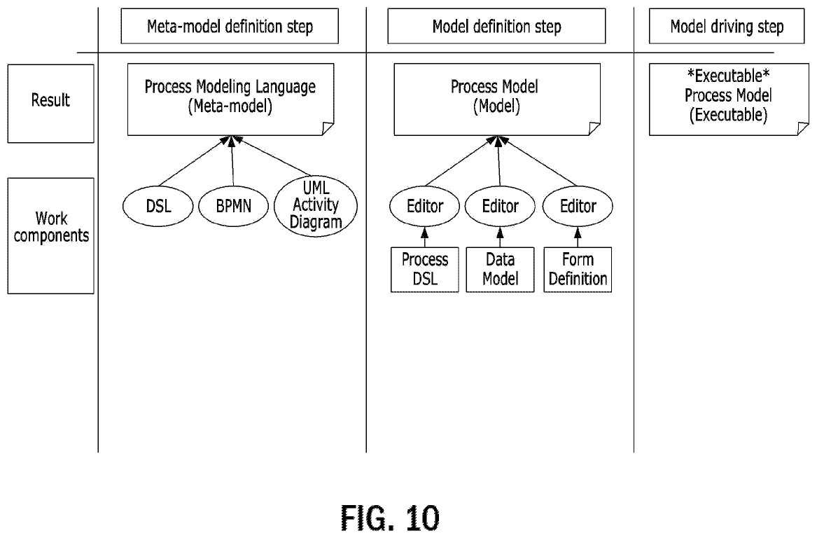

FIG. 9 is a view provided to explain a process framework distribution process according to an embodiment of the disclosure.

The process framework providing system may transform a generated process model into a code that is executable in the framework driving engine 230, and may distribute the code to users of companies.

Specifically, when a process model appropriate for each company is generated based on domain knowledge and requests which are received from users of companies, the process framework providing system may transform the generated process model into a code that is executable in the framework driving engine 230 and may distribute the code to users of companies.

The process model distributed after being transformed into the code may participate in process-based real task performance along with the framework driving engine 230 to perform a business process manager role.

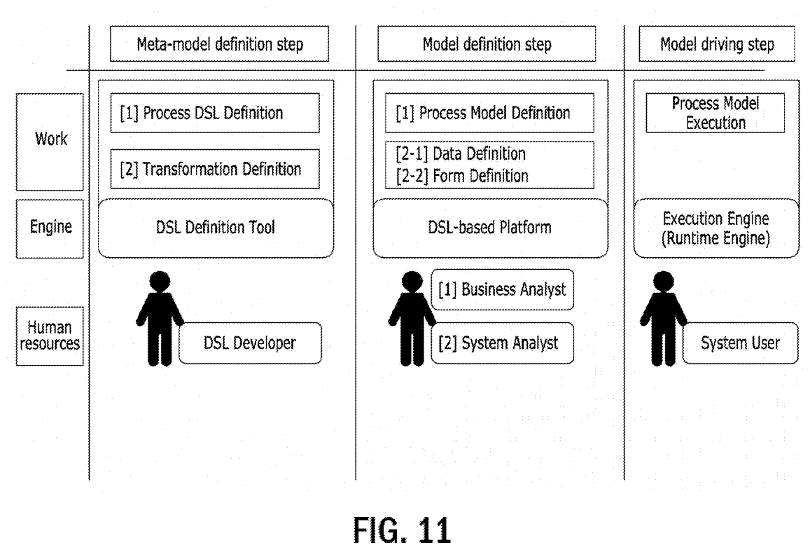

FIGS. 10 to 11 are views provided to explain a structure of a process framework according to an embodiment of the disclosure.

The process framework providing system may perform a step of generating (defining) a metamodel, a step of generating (defining) a process model, and a step of transforming (driving) the process model, and may distribute a framework of the processor 200 to users of companies.

Herein, a result at the step of generating a metamodel is a process modeling language, and a result at the step of generating a process model is a process model.

That is, a metamodel may be created in a process modeling language of any one of a domain-specific language, a business process model and notation (BPMN), and a UML activity diagram. However, the BPMN may be good reference data that embraces all cases, but it is preferable to select a DSL specialized for a corresponding domain in a process framework.

Work components at the step of generating a process model may constitute an edit environment for generating a process model.

Specifically, there are provided an edit environment in which editing is performed based on a process modeling language generated at the step of generating a metamodel, an edit environment in which a data model is connected with respective components, and an edit environment in which a form is created to receive an input from a user.

Through this, a process model may be constituted by complex components in which data and input components are mixed, beyond a graph form in which components are simply collected.

A result at the step of transforming a process model is an executable process model, that is, an execution code.

A process framework may have different work contents, target engines, and work human resources at respective steps.

At the step of generating a metamodel, a DSL developer may generate a process DSL definition and a code conversion definition by using a DSL definition tool.

For example, at the step of generating a process model, a business analyst may primarily be in charge of a process model definition in a platform environment based on a DSL generated at the step of generating a metamodel, and a system analyst may be in charge of a data definition and a user input form definition.

In addition, at the step of transforming the process model, a real system user may perform a task according to the process model driven in the framework driving engine 230.

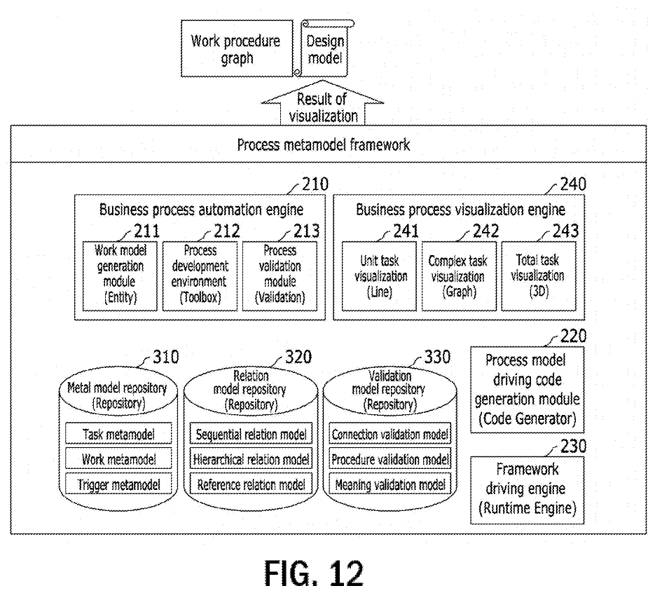

FIG. 12 is a view provided to explain a detailed structure of the process framework providing system according to an embodiment of the disclosure.

Referring to FIG. 12, the process framework providing system may visualize a generated process model through the business process visualization engine 240.

To accomplish this, the business process visualization engine 240 may include a unit task visualization module 241, a complex task visualization module 242, and an entire task visualization module 243.

The unit task visualization module 241 may visualize a unit task among components constituting a process model with a line.

The complex task visualization module 242 may visualize a complex task among components constituting a process model with a graph.

The entire task visualization module 243 may visualize an entire task of a process model in a 3D shape.

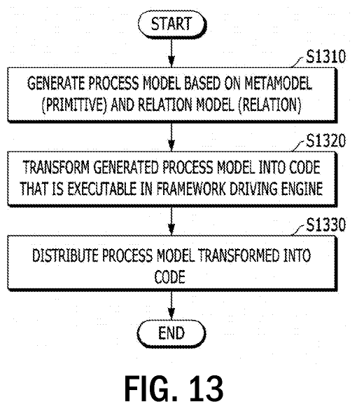

FIG. 13 is a view provided to explain a domain-specific process framework providing method according to an embodiment of the disclosure.

The domain-specific process framework providing method (hereinafter, referred to as a “process framework providing method”) according to an embodiment may be executed by the process framework providing system described above with reference to FIGS. 1 to 12.

Referring to FIG. 13, the process framework providing method may generate a process model based on a metamodel (Primitive) and a relation model (Relation) which are stored in the storage unit 300 (S1310), may transform the generated process model into a code that is executable in the framework driving engine 230 which supports a process model to be driven in a real business environment (S1320), and may distribute the code to a company server and a terminal which need the code (S1330).

In this case, when a real task is performed, the generated process models may be applied to validate a process based on a validation model built therein or provide a service for automatically constituting a process.

In addition, log data stored when a real task is being performed may be used for automatically analyzing through a process analysis tool (an external module).

Through this, a process framework capable of reflecting domain knowledge may be introduced, so that different business processes between companies can be normalized by domain.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the disclosure have been illustrated and described, the disclosure is not limited to the above-described specific embodiments. Various changes can be made by a person skilled in the art without departing from the scope of the disclosure claimed in claims, and also, changed embodiments should not be understood as being separate from the technical idea or prospect of the disclosure.

1. A domain-specific process framework providing method comprising:
a step of generating, by a process framework providing system, a process model based on a metamodel (Primitive) and a relation model (Relation) which are pre-stored; and
a step of distributing, by the process framework providing system, the generated process model.

2. The domain-specific process framework providing method of claim 1, wherein the process framework providing system comprises:
a framework driving engine (runtime engine) configured to support the generated process model to be driven in a real business environment; and
a work model driving code generation module (code generator) configured to transform the process model into a code that is executable in the framework driving engine.

3. The domain-specific process framework providing method of claim 2, wherein the step of generating the process model comprises:
a step of generating the process model based on domain knowledge which is provided from a specific company which intends to drive a process model; and
a step of transforming the generated process model into a code that is executable in the framework driving engine.

4. The domain-specific process framework providing method of claim 3, wherein the metamodel is created in a process modeling language of any one of a domain-specific language (DSL), a business process model and notation (BPMN), and a UML activity diagram.

5. The domain-specific process framework providing method of claim 2, wherein the process framework providing system further comprises a process development environment providing module configured to provide an edit environment for generating the process model.

6. The domain-specific process framework providing method of claim 5, wherein the process development environment providing module is configured to provide at least one edit environment among a first edit environment in which a metamodel (Primitive) is edited based on a process modeling language (Process DSL), a second edit environment in which a relation model (Relation) indicating a connection state between respective metamodels (Primitive) is edited, and a third edit environment in which a form to receive an input from a user is edited.

7. The domain-specific process framework providing method of claim 2, wherein the process framework providing system further comprises:
a metamodel repository configured to store a metamodel; and
a relation model repository configured to store a relation model.

8. The domain-specific process framework providing method of claim 1, further comprising a step of validating, by the process framework providing system, a process of the generated process model before the generated process model is distributed.

9. The domain-specific process framework providing method of claim 1, wherein the process framework providing system further comprises a business process visualization engine configured to visualize the generated process model,
wherein the business process visualization engine is configured to visualize components constituting the process model with a line, a graph, or a 3D shape.

10. (canceled)

11. A domain-specific process framework providing method comprising:
a step of generating, by a process framework providing system, a process model based on a metamodel (Primitive) and a relation model (Relation) which are pre-stored; and
a step of transforming, by the process framework providing system, the generated process model into a code that is executable in a framework driving engine which supports a generated process model to be driven in a real business environment.

12. A domain-specific process framework providing system comprising:
a work model generation module configured to generate a process model based on a metamodel (Primitive) and a relation model (Relation) which are pre-stored; and
a work model driving code generation module configured to transform the generated process model into a code that is executable in a framework driving engine which supports a generated process model to be driven in a real business environment.
